(19) United States
(12) Patent Application Publication
(10) Pub. No.: US 2004/0152381 A1
(43) Pub. Date: Aug. 5, 2004

(54) Fibrous products and methods of making and using them

(75) Inventors: David William York, Newcastle/Tyne (GB); Alan Thomas Brooker, Newcastle/tyne (GB); Shirley Summers, Tyne ?amp; Wear (GB); Jonathan Mark Crowther, Egham (GB); Nigel Patrick Somerville Roberts, Newcastle/Tyne (GB); Adam Thomas Yates, Carrshield (GB); Saswati Datta, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/762,876

(22) Filed: Jan. 22, 2004

Related U.S. Application Data
(60) Provisional application No. 60/504,051, filed on Sep. 18, 2003.
(60) Provisional application No. 60/441,722, filed on Jan. 22, 2003.

(51) Int. Cl. C08J 7/18

(52) U.S. Cl. 442/76; 427/535; 427/487; 442/59

(57) ABSTRACT

Fabrics having a laundry-durable finish made by graft polymerisation of a polymerisable monomer and methods of manufacture thereof which comprise exposing the fabric or a region thereof to a polymerisable monomer and exciting the polymerisable monomer within a monomer excitation zone such as a plasma. The methods of the invention provide oleophobic and hydrophobic stain-resistant fabrics having improved laundry-durability without adversely affecting other textile properties such as textile handle, drape and breathability.

### CROSS REFERENCE TO RELATED APPLICATIONS

This applications claims the benefit of U.S. Provisional Application No. 60/504,051, filed Sep. 18, 2003 (Case CM2724P2) and U.S. Provisional Application No. 60/441,722, filed Jan. 22, 2003 (Case CM2724FP).

This invention relates to the modification of properties of fibrous fabrics and to the resultant fabrics. The invention further relates to making fibrous fabrics having laundry-durable finishes by excitation-induced graft polymerisation of a polymerisable monomer under conditions optimizing the laundry-durability of the finish, other textile properties such as textile handle, drape and breathability, as well as the speed and efficiency of the manufacturing process.

It is well known to apply surface treatments to a fabric (or the yarns or fibres from which it is made) so as to modify the properties of the fabric. These methods all involve the application of a treatment material or finishing agent to the surface of the fabric (or the yarns or fibres from which it is made) under conditions whereby the active material is held to the surface. The treatment material is retained on the fabric chemically and/or physically, depending upon the combination of active chemical, fibre type and method of application.

The most common way of applying treatment material is by applying a solution or emulsion of the chemical by padding, immersion, spraying, printing or other contact technique. The solvent is then evaporated to leave the treatment material physically and/or chemically bonded to the fabric. For instance it is conventional to impart water and oil repellence to a fabric by application of an aqueous emulsion of a fluorochemical.

It is also known to treat fabrics by contacting the fabric with the treatment material in vapour form. In order to promote retention of the treatment material on the fabric, it is known to apply it as a polymer and/or in combination with a binder. It is also known to apply it in polymerisable form and to polymerise it on the fabric.

As a generality, a problem with fabric treatments is that it is difficult to achieve permanence of the desired effect without sacrificing other desired properties. This is particularly for use of the natural fabrics such as cotton, silk, wool etc. Moreover it is difficult to achieve and maintain a combination of high performance, durability and good textile characteristics under high speed manufacturing conditions.

Accordingly many fabric treatments are insufficiently permanent. This is a particular problem when the fabric is clothing or other domestic textile which is laundered or dry cleaned frequently, since agitated washing and solvents tend to strip the deposited treatment material off the fabric and soil deposition can also interfere with performance. For instance known oleophobic treatments normally lose their effectiveness after a few washes or dry cleaning treatments. Moderate permanence on man-made fabrics can sometimes be achieved but only by the use of textile attributes such as a curing system and/or a binder, and this can impair either the softness and/or permeability of the fabric.

As an example, it is well known to render a fabric oleophobic by applying an emulsion of perfluoro compound to it. This generates a fabric which is oleophobic and hydrophobic but it has two major disadvantages. One is that the fabric loses permeability and handle. Microscopic examination shows the presence of a large amount of film-forming material bridging between fibres. The other disadvantage is that the treatment is not permanent in that the fabric loses its oleophobic properties relatively quickly upon exposure to normal weather or wear and, in particular, after being subjected to only a few (for instance three or five) normal agitated washes i.e., washes of the normal type to which clothing is subjected in a washing machine. Permanence to dry cleaning, on the other hand, can be even more deficient. Increasing the amount of emulsion above an amount that gives good oleophobicity does not improve permanence, and worsens handle, drape and other textile attributes.

These problems apply in respect of treatments that have been designed specifically for fabrics, but they apply also to treatments which have been developed predominantly for applying active chemicals as films on solid surfaces but which have also been mentioned as capable of being applied to fabrics.

One class of coating treatment involves plasma-enhanced deposition of a treatment material in vapour form onto a substrate. There are various types of plasma-enhanced deposition processes, including deposition at atmospheric pressure or at reduced pressure, deposition by use of a continuous, pulsed or varying flow of active chemical, and deposition using a continuous plasma discharge or a pulsed plasma discharge. When a pulsed discharge is used the disclosures show pulses having an “on time” ranging from microseconds (us) up to seconds and an “off time” also ranging from microseconds up to seconds, with the ratio of the on:off times typically ranging from 1:1 to 1:10, or sometimes considerably more. The wide range of conditions exists because of the difficulty of selecting conditions which achieve the required amount of activation without causing over-activation or premature activation and consequential unwanted reactions.

There are also disclosures in which a plasma discharge is used to activate the substrate surface before exposing the surface to a treatment material that will react with it (see for example JP 10325078 and U.S. Pat. No. 5,328,576). There are also disclosures where a bifunctional reagent is subjected to plasma deposition onto a smooth substrate whereby the bifunctional reagent reacts with one of its functional groups (generally with polymerisation) to the surface of the substrate and its other functional group is subsequently caused to react covalently with a treatment material. As a result, the treatment material is linked to the substrate by the bifunctional reagent that has been deposited by plasma (see for example U.S. Pat. No. 5,876,753).

Plasma deposition processes are usually described in the context of providing a continuous film of coating material on a continuous solid substrate. However fabrics are included in the list of substrates in a few of the disclosures. As an example, in EP-A-0,896,035 it is described that a transparent film free of pinholes can be obtained on a substrate, and fabrics are included in the list of possible substrates.

There have also been a few disclosures of plasma treatments using polymerisable monomers which are specific for fabrics.

For example U.S. Pat. No. 3,674,667 describes rendering fabric water repellent by plasma deposition of certain fluorocarbons. It warns that if an unsaturated fluorocarbon is used polymerisation will predominate and the treated fabric will lose its handle and permeability.

In U.S. Pat. No. 5,041,304 a fabric is subjected to plasma deposition of a fluorocarbon in an inert gas at atmospheric pressure.

In RU-A-1158634, a textile surface is activated by plasma and is then exposed to acrylic monomer vapour.

In WO 00/14323 two different processes are described for forming an oleophobic and hydrophobic coating on a textile. In one process plasma deposition of a fluorocarbon is utilized, and plasma deposition is defined as providing a partly cross-linked, void-free, continuous coating which is well adherent to the substrate. The process conditions involve exposing the substrate to a pulsed plasma with, preferably, an on time of about 10 ms and an off time of about 190 ms. In the other process, the textile is exposed to deposition of a vapour of a perfluoroalkyl acrylate whereby the monomer condenses on the textile surface, and the deposited monomer is then exposed to a source of radiation to cause polymerisation.

These processes do not give the optimum combination of oleophobicity, textile handle and permanence.

In WO 98/58117 a process is described for coating a surface with a polymer layer by exposure to a plasma containing a monomeric unsaturated perhalogenated compound whereby the layer renders the surface oil or water repellant. In some examples the surface was the surface of a fabric which was exposed to low pressure, pulsed, plasma deposition of a perfluoralkyl acrylate. The resultant fabric was subjected to a single, static, extraction test and was found to retain its hydrophobic and oleophobic properties after this static test. This extraction test gives an indication of permanence against a single, static, solvent extraction but gives no indication whatsoever of permanence against the conditions encounted by normal clothing and other normal domestic textiles, especially including repeated agitated wash cycles.

There is no indication of the permanence of the coating, and in particular there is no suggestion that the coating might simultaneously give good permanence against agitated washing, while maintaining good permeability and handle. In practice fabrics coated according to the conditions disclosed in this patent have been found to display poor durability under typical laundering conditions.

An objective of the invention therefore is to provide a finishing process for fabrics intended or suitable for use in typical personal, domestic, institutional and workplace applications which are subject to regular or occasional laundering or cleaning including for example clothing, bedding, curtaining, table linen and related items and apparel and wherein the fabrics are characterized by improved laundry-durability together with other textile properties such as textile handle, drape and breathability. Another objective is to provide a process for making oleophobic and hydrophobic stain-resistant fabrics having improved laundry-durability. A further objective is to provide a process for making laundry-durable fabrics based on excitation-induced graft polymerisation of a polymerisable monomer and which is typified by improved speed and efficiency. Yet another objective is to provide a process for making laundry-durable fabrics using polymerisable monomers having improved laundry-durability and stability.

### SUMMARY OF THE INVENTION

The present invention relates in part to a method for making a fabric having a laundry-durable finish by excitation-induced graft polymerisation of a polymerisable monomer in which the fabric or a region of the fabric (which term includes one or more treatment areas on one or both sides of the fabric) is exposed to polymerisable monomer and the polymerisable monomer is excited within a monomer excitation zone.

The methods of the invention lead to the deposition of an extremely thin but coherent, conformal and durable graft-polymerised coating or region at or near the surface of the fibres. In preferred embodiments, the polymer-coated fabric or region thereof has an average fibre-coating thickness of at least about 1.5 nm, preferably at least about 2.5 nm, more preferably at least about 3 nm, and especially at least about 8 nm, the average thickness of the coating ranging up to about 25 nm, preferably about 20 nm and more preferably about 15 nm, such coatings being preferred from the viewpoint of providing optimum durability of the finishing effect during laundering (both wet and dry-cleaning) as well as excellent textile attributes including breathability, drape and handle. In addition, the exposure and excitation conditions are preferably such that the fabric or region thereof has a coating abrasion resistance of at least about 1000, preferably at least about 3000 rubs according to the test protocol described in detail below, the coating abrasion resistance being a measure of the ability of the coated fabric to maintain at least a minimum level of finishing performance (at least 50% of initial) under standard mechanical abrasion conditions (Martindale Abrasion Test, British Standard BS EN ISO 12947-2:1999, 12 kPa load). In addition it is preferred that the fabric will continue to meet the appropriate minimum industrial standard for the particular fabric finish for at least about 1000, preferably at least about 3000 rubs, for example, in the case of stain resistant finishes, a minimum value of 3 according to the industry standard oil repellency and/or water repellency tests (see below).

The average fibre-coating thickness can be determined herein directly (using well-known surface analytical techniques such as sem, fe-sem, aes, cryo-tem, ftir, xps, sims, etc) or by estimation from the amount of polymerisable monomer that is deposited and the surface area of the fibres (measured for example by N₂-based BET techniques), assuming the polymer and liquid monomer to have the same density (δ). For liquid feed, the average fibre-coating thickness in nm (τ) is defined as

τ=fₗ.ε.1000/(a_{w}.a_{f}.w_{b})

where fₗ is the monomer feed rate in ml/min, ε is the empirically-determined deposition efficiency expressed on a fractional basis, a_{w} is the web treatment rate in m²/min, a_{f} is the surface area of the fibres in m²/g, and w_{b} is the basis weight of the fabric in g/m², the expression for τ being summed as appropriate where the fabric is subject to multiple passes or repeated treatments. For vapour feed, a similar relationship holds except that the monomer feed rate fᵥ is normally measured in mol/min so that

fₗ=fᵥ.M_{w}/δ

where M_{w} is the molecular weight of the monomer and δ is the density of the monomer liquid at ambient temperature measured in g/cm³.

For a static process, the web treatment rate is represented by the ratio of the area of the web in m² and the total reaction time in min (tᵣ).

Although the average fibre-coating thickness is extremely small, preferably the coating has an average thickness greater than the xps inelastic mean free path parameter (λ) across the range of electron energies typically encountered in the xps of organic materials (200-800 eV) whereby there is essentially no contribution to the xps spectrum from atoms of the underlying bulk fibre material (such as C, N and O). Moreover, the fibre coating preferably meets this thickness criterion across at least about 50%, more preferably at least about 75%, and especially at least about 95% of the fabric or treated region thereof.

It is also preferred that the polymer be graft-polymerised substantially wholly on or in the individual fabric fibres with substantially no coalescence of fibre bundles whereby there are substantially no films of treatment material interconnecting adjacent, substantially parallel fibres of the fibre bundles, this being important again for maintaining excellent textile handle, drape and breathability characteristics. Coalescence or partial coalescence of fibre bundles can be observed directly in 500×photomicrographs of the fabric, but coalescence can in turn lead to yarn shrinkage and this manifests itself in terms of increased inter-yarn pore size and air permeability. Preferably therefore the air permeability (measured for example using a Textest FX3300 Air Permeability Tester III at a pressure gradient of 125 Pa according to ASTM D737-96) of the fabric or region thereof after treatment and prior to laundering should be within about ±20%, more preferably about ±15%, and especially about ±10% of that of the untreated fabric. By controlling the average fibre-coating thickness, the polymerisable monomer type, monomer adjuncts and the exposure and excitation conditions to control abrasion resistance, it becomes possible to deliver at one and the same time excellent finish performance characteristics such as oleophobic and hydrophobic stain repellence as well as improved durability and permanence of the finishing effect during wet and dry laundering without adversely impacting on other textile attributes such as drape, breathability and handle.

Thus according to one aspect of the invention, there is provided a method for making a fabric having a laundry-durable finish by excitation-induced graft polymerisation of a polymerisable monomer, the method comprising

a) exposing the fabric or a region thereof to polymerisable monomer, and

b) exciting the polymerisable monomer within a monomer excitation zone,

and wherein the polymerisable polymer and exposure conditions are such that the resulting polymer-coated fabric or region thereof has an average fibre-coating thickness of from about 1.5 to about 25 nm, preferably from about 3 to about 20 nm, and more preferably from about 8 to about 15 nm, and wherein the polymer is graft-polymerised substantially wholly on or in the individual fabric fibres with substantially no coalescence of fibre bundles. Preferably the coating abrasion resistance of the fabric or region thereof is at least about 1000, more preferably at least about 3000 rubs (Martindale Abrasion Test, ISO 12947-2, 12 kPa load, 50% minimum finishing performance), while the air permeability of the fabric or region thereof after treatment is preferably within about ±20%, more preferably about ±15%, and especially about ±10% of that of the untreated fabric.

As a result of fibre bridging by films of treatment material or of uneven surface treatment, conventional coating processes can also lead to an increase in the surface area of the fibre bundles, which can be measured for example by BET analysis (for example using a Micromeritics Gemini with N₂ as the operating gas). Accordingly it is preferred that the BET surface area of the fabric or region thereof after treatment (sometimes referred to herein as the fibre surface area) is preferably within about ±20%, more preferably about ±15%, and especially about ±10% of that of the untreated fabric.

The present invention also relates to fabrics that have been finished by treatment with a polymerisable monomer. Thus in a fabric embodiment of the present invention, there is provided a fabric having a laundry-durable finish made by graft polymerisation of a polymerisable monomer, the polymer-coated fabric or region thereof having an average fibre-coating thickness of from about 1.5 to about 25 nm, preferably from about 3 to about 20 nm, and more preferably from about 8 to about 15 nm, and a coating abrasion resistance of at least about 1000, more preferably at least about 3000 rubs (Martindale Abrasion Test, ISO 12947-2, 12 kPa load, 50% minimum finishing performance), the polymer being graft-polymerised substantially wholly on or in the individual fabric fibres with substantially no coalescence of fibre bundles whereby the air permeability of the fabric or region thereof after treatment is within about ±20%, more preferably about ±15%, and especially about ±10% of that of the untreated fabric.

A wide range of polymerisable monomers as well as finishing materials and compositions incorporating polymerisable monomers are suitable for application to fabrics herein, the monomer being selected on the basis of the desired fabric finish and on the ability of the monomer to impart the required finish by polymerisation or graft polymerisation. Preferably however, the polymerisable monomer is selected to impart one or more laundry-durable finishes selected from oleophobicity, hydrophobicity, stain repellency stain release, soil-resistance, soil release, malodor resistance, malodor release, crease resistance, softness, flame retardancy, color-bleeding resistance, dye-transfer inhibition, and odor receptivity.

Of the above, highly preferred are monomers designed to impart laundry-durable stain repellency, and especially laundry-durable oleophobic stain repellency, particularly under medium to heavy soil load conditions and on natural and semi-natural fabrics, two areas in which the prior art has proved notably deficient in delivering effective laundry-durable performance. Thus in highly preferred embodiments herein, the fabric is a natural or semi-natural, preferably multifilament yarn-based woven fabric made, for example, of cotton, silk, wool, linen, rayon or of mixtures thereof, or a blend of natural fibres with one or more synthetic polymers in fibre form.

The stain repellency of the treated fabrics for oil- and water-based stains can be measured in a number ways including use of the industrial standards AATCC 118-1997 (technically equivalent to ISO 14419) for oil (or oleophobic) stain repellency and 3M's Water Repellency Test for water-based (hydrophobic) stain repellency, the protocols for which are set out below. Using the industry standard tests, the fabric of the invention, or at least the treated region thereof, preferably has a stain repellency value (at least one and preferably both of oleophobic and hydrophobic stain repellency) prior to first laundering of at least 5, more preferably at least 6, and most preferably at least 7. Moreover, the fabric will preferably maintain a stain repellency value of at least 3 for 10 or more laundry treatments (wet or dry), and preferably for at least 15 or 20 laundry treatments under medium soil load conditions (see typical multi-cycle wash conditions set out below). Ideally, the fabric will have a grade of 3 or higher for as much as 30 or 40 laundry treatments or more. Although the stain-repellent effect can be partially restored and the durability of stain repellency prolonged by hot ironing the fabric after laundering, it is a feature of the invention that hot ironing is not required to achieve excellent durability. By contrast the known commercial treatments of fabrics based on emulsion polymerisation chemistry achieve only poor durability, even after ‘prolongation’ by hot ironing.

Polymerisable monomers suitable for use herein for providing stain repellency can also be selected on the basis of contact angle hysteresis factors, this being a measure of the relative difference of advancing and receding contact angles for various liquids on the surface of the polymer-coated fabrid. Thus in preferred embodiments, the polymer-coated fabric or region thereof has an average wetting hysteresis factor for n-hexadecane of less than about ±30%, preferably less than about ±20% and more preferably less than about ±10%, wherein the n-hexadecane wetting hysteresis factor is defined as (θₐ^{hex}−θᵣ^{hex)/θ}ₐ^{hex}, and θₐ^{hex}, θᵣ^{hex} are respectively the advancing and receding contact angles for n-hexadecane on the polymer coated fabric or region thereof at 20° C. Moreover, the fabric or region thereof preferably also has an average wetting hysteresis factor for water of less than about ±30%, preferably less than about ±20% and more preferably less than about ±10%, wherein the water wetting hysteresis factor is defined as (θₐ^{wat}−θᵣ^{wat})/θₐ^{wat}, and θᵣ^{wat} are respectively the advancing and receding contact angles for deionised water on the polymer coated fabric or region thereof at 20° C.

In preferred aspects of the invention, the fabric or a region thereof is exposed to the polymerisable monomer in gaseous or in vaporized but condensable form, for example using so-called flash evaporation techniques in which the monomer is atomized and flash vaporized by contact with a heated surface tube above the boiling point of the monomer followed by condensation on the fabric so as to coat the individual fabric fibres.

In preferred embodiments, the polymerisable monomer is discharged in atomized form into a flash evaporation chamber or vaporization tube using for example one or more piezoelectric, ultrasonic, electrostatic or acoustic atomisers or a combination thereof. The median size of the atomized droplets is preferably from about 1 μm to about 100 μm, more preferably from about 15 μm to about 70 μm. Suitable ultrasonic atomizers for use herein include those supplied by Sono-Tek Corporation, Milton, N.Y., USA. The monomer will generally be fed to the atomizer in liquid or liquefiable form using gravity feed or preferably a positive displacement or other suitable metering pump designed to provide a feed rate generally in the range from about 0.05 ml/min to about 1000 ml/min, preferably from about 1 ml/min to about 200 ml/min, more preferably from about 5 to about 100 ml/min.

Graft-polymerisation of the polymer to the fabric fibres is undertaken using excitation-induced polymerization within an excitation zone. Suitable excitation processes include radiative processes using for example UV and electron beam excitation, but highly preferred herein from the viewpoint of providing optimum finishing performance and laundry durability are plasma-based excitation processes. Accordingly, the excitation zone herein is preferably selected from radiofrequency- and microwave-generated plasma zones as discussed in more detail below.

Although the present invention generally encompasses the use of both continuous and atmospheric plasmas, in preferred embodiments the excitation zone takes the form of a pulsed plasma and especially a sub-atmospheric vacuum pulsed plasma, wherein the duty cycle, excitation power and other plasma conditions are adjusted so as to maximize graft polymerization and minimize both polymer fragmentation and inter-fibre or intra-yarn film formation.

Although a broad range of excitation conditions and duty cycles are suitable herein depending, among other things, on monomer type, reactivity and state of matter at the point of excitation, pulsed plasmas for unsaturated vapor phase monomers typically have a pulse on-time (tₒₙ) in the range from about 5 μs to about 100 μs, preferably from about 20 μs to about 70 μs, while for saturated vapor-phase monomers longer on-times may be appropriate, for instance from about 40 μs to about 2 μs, preferably from about 100 μs to about 1 ms The pulse off-time (t_{off}) on the other hand is generally at least 1 ms and preferably is in the range from about 2 ms to about 50 ms, and more preferably from about 5 ms to about 30 ms. The duty cycle (tₒₙ/(tₒₙ+t_{off})) meanwhile preferably lies in the range from about 1/2to about 1/10000, preferably from about 1/100 to about 1/5000 for unsaturated vapor-phase monomers and from about 1/4 to about 1/300, more preferably from about 1/5 to about 1/40 for saturated vapor-phase monomers. In the case of saturated vapor-phase monomers, however, it will be understood that continuous rather than pulsed plasma operating conditions may be suitable in many instances.

In addition, the pulsed plasma or other excitation zone preferably has an average excitation power density (average power applied per unit area of fabric) in the range from about 10⁻⁷ to about 10⁻¹, preferably about 10⁻⁶ to about 10⁻² Watts/cm², with from about 10⁻⁴ to about 10⁻² Watts/cm² being preferred for saturated vapor-phase monomers and from about 10⁻⁵ to about 10⁻⁴ Watts/cm² for unsaturated vapor-phase monomers, the pulsed plasma power being defined as usual as (tₒₙ/(tₒₙ+t_{off})). Wₒₙ where Wₒₙ is the power applied during the pulse on-time.

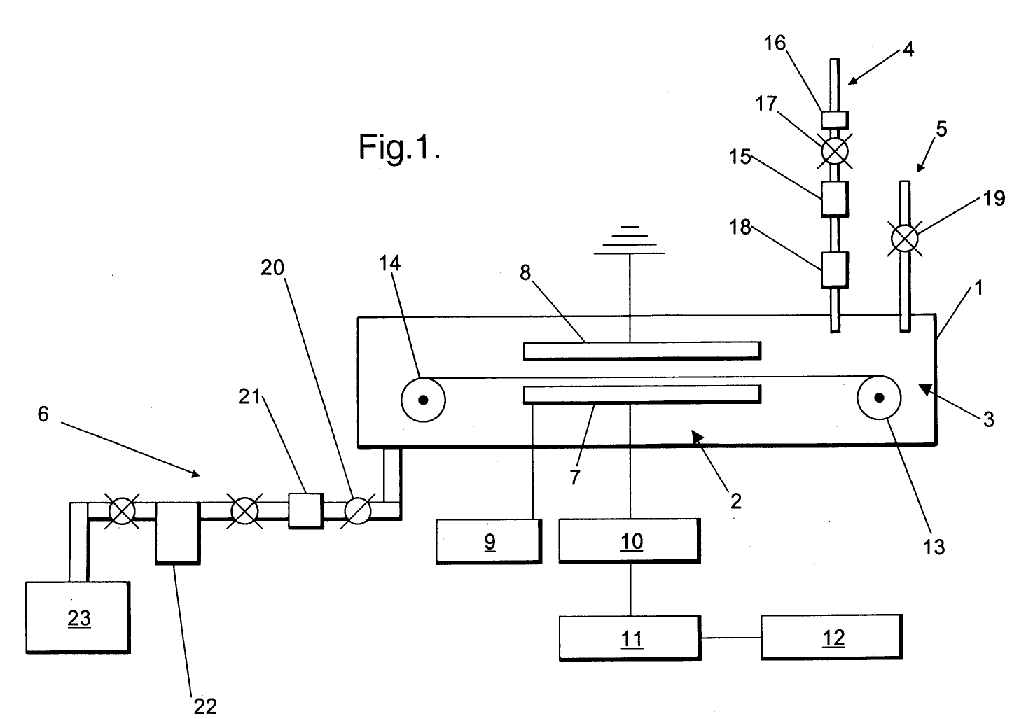

Sub-atmospheric vacuum pulsed plasmas herein preferably operate at a pressure (measured downstream of the vacuum chamber housing—see FIG. 1) in the range from about 7.5 to about 7500 mTorr (0.01 to 10 mbar; 1 to 1000 Pa), more preferably from about 50 to about 2000 mTorr (0.067 to about 2.67 mbar; 6.7 to 266.6 Pa), especially from about 75 to about 400 mTorr (0.1 to about 0.533 mbar; 10 to 53.3 Pa).

The polymerisable monomer preferred for use herein for purposes of providing optimum oleophobic and hydrophobic stain resistance is a saturated or unsaturated long-chain fluoro-substituted monomer containing an uninterrupted fluoroalkyl group of formula CₙX₂ₙ₊₁ wherein each X is independently selected from halogen and H and wherein the fluoroalkyl group contains at least n, preferably at least 2n-3 and more preferably 2n+1 fluoro substituents, wherein n is in the range from about 4 to about 20, preferably from about 5 to about 15, more preferably from about 5 to about 12, and especially from about 6 to about 10. The fluoroalkyl group can be linear or branched but preferably it contains a linear fluorocarbon segment of at least about 4, more preferably at least about 5 carbon atoms in length. By ‘uninterrupted’ is meant that the fluoroalkyl group contains no chain-interrupting CH₂ groups. The term ‘linear segment’ on the other hand refers to a segment of the fluoroalkyl group having linearly-connected carbon atoms, albeit possibly with one or more side-chains branched therefrom, which side-chains do not count towards the total number of carbon atoms in the segment. Preferably the fluoroalkyl group has the general formula CₙF₂ₙ₊₁. Such monomers are capable of providing good oleophobic stain resistance in flash-evaporation, radiative-induced (uv or electron-beam) polymerization processes, though they are especially effective for stain resistance and durability in the preferred plasma-induced polymerization processes of the invention.

More specifically, suitable polymerisable monomers for purposes of stain resistance preferably have the general formula [CₙX₂ₙ₊₁YTQ]ₘR, wherein R is selected from optionally halo-substituted C₁-C₈-alkyl or alkylene, C₃-C₈-cycloalkyl or cycloalkylene, C₂-C₈-heterocycloalkyl or heterocycloalkylene, C₂-C₈-alkenyl or alkenylene, C₂-C₈-alkynyl or alkynylene, and C₄-C₈-alkadienyl or alkadienylene, m is from 1 to 3, preferably 1; T represents (C(R¹)₂)ₚ wherein each R¹ independently represents H, halogen, hydroxy, an optionally hydroxy- or halo-substituted C₁-C₄ alkyl group, or a mono- or poly-C₁-C₄-alkylene oxide moiety and p is from 0 to 10, preferably from 0 to 5, more preferably from 0 to 2; each Q independently represents a direct bond or a linking moiety selected from O, (C═O), O(C═O), (C═O)O, NR², NR²(C═O), (C═O)NR², O(C═O)NR² and (R²)₂Si, wherein, each R² independently represents an optionally halo-substituted C₁-C₄ group; and Y is a direct bond or a sulphonamide group, for example of formula SO₂N(R³) wherein R³ is hydrogen or an optionally halo-substituted C₁-C₄ group, preferably methyl or ethyl, provided that when Y is a sulphonamide group, the corresponding T moiety has a p value of at least 1. Where Y represents a direct bond and p is greater than 0, carbon atoms are assigned between the fluoroalkyl group and T following the rule that the fluoroalkyl group contains no chain-interrupting CH₂ groups.

Preferred polymerisable monomers herein are unsaturated or cyclic (the unsaturated monomers being preferred) and include:

a) substituted alkene compounds of formula CₙX₂ₙ₊₁R, wherein R is selected from optionally halo-substituted alkenyl groups having from 2 to 8, preferably from 2 to 4, and more preferably 2 carbon atoms,

b) substituted alkyne compounds of formula CₙX₂ₙ₊₁R, wherein R is selected from optionally halo-substituted alkynyl groups having from 2 to 8, preferably from 2 to 4, and more preferably 2 carbon atoms,

c) substituted alkadienyl compounds of formula CₙX₂ₙ₊₁R, wherein R is selected from optionally halo-substituted alkadienyl groups having from 4 to 8, preferably from 4 to 6, and more preferably 4 carbon atoms,

d) substituted heterocycloalkyl compounds of formula CₙX₂ₙ₊₁R, wherein R is selected from optionally halo-substituted heterocycloalkyl groups having from 2 to 8, preferably from 2 to 5, more preferably 2 to 3 cyclic carbon atoms and one or more heteroatoms, preferably O,

e) alkenoic acid esters of formula CₙX₂ₙ₊₁O₂CR wherein R is selected from optionally halo-substituted alkenyl groups having from 2 to 8, preferably from 2 to 4, and more preferably 2 carbon atoms, and

f) sulphonamide-substituted alkenoic acid esters of formula CₙX₂ₙ₊₁SO₂N(R³)(C(R¹)₂)ₚO₂CR wherein R is selected from optionally halo-substituted alkenyl groups having from 2 to 8, preferably from 2 to 4, and more preferably 2 carbon atoms, each R¹ independently represents H, halogen, or an optionally halo-substituted C₁-C₄ alkyl group, p is from 1 to 10, preferably from 1 to 5, more preferably 2, and R³ is hydrogen or an optionally halo-substituted C₁-C₄ group, preferably methyl or ethyl,

Preferred herein from the durability viewpoint are monomers, particularly of classes a) to f) above, wherein the terminal carbon of the fluoroalkyl group or of T, if present, is free of H substituents when the corresponding group is directly connected to a Q linking moiety; and wherein the polymerisable monomer is perfluorinated when the monomer is free of Q linking moieties. Suitably the terminal carbon of the fluoroalkyl group or of T, if present, is substituted with two atoms or groups selected from the halogens, especially fluorine, C₁-C₄ alkyl moieties optionally substituted with one or more halo or hydroxy substituents, poly-C₁-C₄-alkylene oxide moieties having from 2 to 20 alkylene oxide moieties in the polymer chain, and combinations thereof. Highly preferred from the viewpoint of optimizing stain resistance and durability whilst maintaining an acceptable biodegradability profile are fluorine terminal substituents and fully perfluorinated monomers.

In the case of Q-linked monomers such as the carboxylic esters, substitution on the terminal carbon, for example by one or two C₁-C₄ alkyl groups, can also be valuable for improving laundry durability by minimizing hydrolytic degradation and consequent loss of polymer from the fibre surface. Selection of Q linking moieties other than carboxy, for example, carbamates, can also greatly reduce hydrolytic degradation. Preferably therefore the polymerisable monomer has a rate constant for alkaline hydrolysis at pH 8 and above of less than about 8×10⁻², more preferably less than about 5.3×10⁻², yet more preferably less than 4.5×10⁻³, and especially less than about 1×10⁻⁵ L/mol-sec; or expressed in half-life terms, a half-life for alkaline hydrolysis at pH 8 of at least about 100 days, preferably at least about 150 days, more preferably greater than 1 year, and especially greater than about 1000 years.

The processes of the invention are capable of providing stain repellent fabrics having a high fluorine surface density to provide excellent repellency performance that is maintained for 10 or more laundry treatments (wet or dry), and preferably for at least 15 or 20 laundry treatments. Preferably the fabrics when made have an F:C ratio as determined by XPS of at least about 1.10, preferably at least about 1.15, more preferably at least about 1.20, and especially at least about 1.25. The surface fluorine atomic concentration, on other hand, is preferably at least about 48%, more preferably at least about 50% and especially at least about 52%. The CF₂:CₓH_{y} ratio determined from XPS C(1s) spectra is preferably at least about 1.0, more preferably at least about 2.0, even more preferably at least about 2.5 and especially at least about 3.0, wherein CₓH_{y} is the reference offset at 285 eV and the CF₂ peaks generally lie between about 5.5 and 7.5 eV above reference.

Moreover, although successive laundry treatments lead eventually to an increase in surface O concentration, at least in part because of soil deposition, stain repellency is surprisingly maintained in the presence of significant surface O. For example, the cotton fabrics of the invention display excellent soil repellency performance at levels of surface O concentration as high as 25% whereas conventionally treated cotton fabrics lose their performance at much lower levels in the region of 10-18%. This reflects the fact that conventionally treated cotton fabrics are particularly prone to loss of soil repellency after washing in medium to high soil loads.

It is a feature of the invention that the polymerisable monomers preferred for use in the excitation-induced graft polymerization processes of the invention are also highly suitable for providing stain resistance, albeit of somewhat limited durability and effectiveness on natural fabrics, in conventional wet- or emulsion based polymerization textile treatment processes well-known in the art. Thus in a use aspect of the invention, there is provided the use of a polymerisable monomer for coating a fabric to impart a stain-resistant finish, and wherein

a) the monomer is a saturated or unsaturated long-chain fluoro-substituted monomer containing an uninterrupted fluoroalkyl group of formula CₙX₂ₙ₊₁ wherein each X is independently selected from halogen, H and O-linked sidechain substituents and wherein the fluoroalkyl group contains at least n, preferably at least 2n−3 and more preferably 2n+1 fluoro substituents, wherein n is in the range from about 4 to about 20, preferably from about 5 to about 15, more preferably from about 5 to about 12, and especially from about 6 to about 10 and wherein the fluoroalkyl group contains a linear fluorocarbon segment of at least about 4, preferably at least about 5 carbon atoms in length;

b) the monomer has the general formula [CₙX₂ₙ₊₁YTQ]ₘR, wherein R is selected from optionally halo-substituted C₁-C₈-alkyl or alkylene, C₃-C₈-cycloalkyl or cycloalkylene, C₂-C₈-heterocycloalkyl or heterocycloalkylene, C₂-C₈-alkenyl or alkenylene, C₂-C₈-alkynyl or alkynylene, and C₄-C₈-alkadienyl or alkadienylene, m is from 1 to 3, preferably 1; T represents (C(R¹)₂)ₚ wherein each R¹ independently represents H, halogen, hydroxy, an optionally hydroxy- or halo-substituted C₁-C₄ alkyl group, or a mono- or poly-C₁-C₄-alkylene oxide moiety and p is from 0 to 10, preferably from 0 to 5, more preferably from 0 to 2; each Q independently represents a direct bond or a linking moiety selected from 0, (C═O), O(C═O), (C═O)O, NR², NR²(C═O), (C═O)NR², O(C═O)NR² and (R²)₂Si, wherein, each R² independently represents an optionally halo-substituted C₁-C₄ group; and Y is a direct bond or a sulphonamide group provided that when Y is a sulphonamide group, the corresponding T moiety has a p value of at least 1; and wherein preferably

c) the terminal carbon of the fluoroalkyl group or of T, if present, is free of H substituents when the corresponding group is directly connected to a Q linking moiety; and wherein the polymerisable monomer is perfluorinated when the monomer is free of Q linking moieties.

It is also a feature of the invention that polymerisable monomers selected herein on the basis of their ability to provide laundry durable stain repellency also provide a number of ancillary benefits including laundry-durable dye transfer inhibition, whiteness maintenance performance, improved color fidelity, malodor resistance, and improved fabric drying characteristics. Thus in a further use aspect of the invention, there is provided the use of a polymerisable monomer for excitation-induced graft polymerization to a fabric for imparting a laundry durable stain-resistant finish together with one or more ancillary benefits selected from laundry-durable dye transfer inhibition, whiteness maintenance performance, improved color fidelity, malodor resistance, and improved fabric drying characteristics, and wherein

a) the monomer is a saturated or unsaturated long-chain fluoro-substituted monomer containing an uninterrupted fluoroalkyl group of formula CₙX₂ₙ₊₁ wherein each X is independently selected from halogen, H and O-linked sidechain substituents and wherein the fluoroalkyl group contains at least n, preferably at least 2n−3 and more preferably 2n+1 fluoro substituents, wherein n is in the range about 4 to about 20, preferably from about 5 to about 15, more preferably from about 5 to about 12, and especially from about 6 to about 10 and wherein the fluoroalkyl group contains a linear fluorocarbon segment of at least about 4, preferably at least about 5 carbon atoms in length;

b) the monomer has the general formula [CₙX₂₊₁YTQ]ₘ R, wherein R is selected from optionally halo-substituted C₁-C₈-alkyl or alkylene, C₃-C₈-cycloalkyl or cycloalkylene, C₂-C₈-heterocycloalkyl or heterocycloalkylene, C₂-C₈-alkenyl or alkenylene, C₂-C₈-alkynyl or alkynylene, and C₄-C₈-alkadienyl or alkadienylene, m is from 1 to 3, preferably 1; T represents (C(R¹)₂)ₚ wherein each R¹ independently represents H, halogen, hydroxy, an optionally hydroxy- or halo-substituted C₁-C₄ alkyl group, or a mono- or poly-C₁-C₄-alkylene oxide moiety and p is from 0 to 10, preferably from 0 to 5, more preferably from 0 to 2; each Q independently represents a direct bond or a linking moiety selected from 0, (C═O), O(C═O), (C═O)O, NR², NR²(C═O), (C═O)NR², O(C═O)NR² and (R²)₂Si, wherein, each R² independently represents an optionally halo-substituted C₁-C₄ group; and Y is a direct bond or a sulphonamide group provided that when Y is a sulphonamide group, the corresponding T moiety has a p value of at least 1; and wherein preferably

c) the terminal carbon of the fluoroalkyl group or of T, if present, is free of H substituents when the corresponding group is directly connected to a Q linking moiety; and wherein the polymerisable monomer is perfluorinated when the monomer is free of Q linking moieties.

It is preferred herein that the polymerisable monomer be of low or intermediate volatility with a boiling point in the range from about −50° C. to about 150° C., preferably from about −20° C. to about 100° C. at 8000 mTorr (10.7 mbar) although mixtures of polymerisable monomers of differing volatility or of volatile or non-volatile polymerisable monomers with polymerisable or non-polymerisable reactive gases are also suitable for use herein for purposes of optimising e.g. stain resistance and manufacturing rate.

The methods of the invention can be applied using either a single or a plurality of excitation zones, but in a preferred process using a plurality of excitation zones, the fabric or one or more regions thereof is subjected to different excitation conditions within different excitation zones. The different excitation conditions applied in the different zones can be selected for example from different duty cycles, electrode temperatures, power parameters, pressure conditions, electromagnetic phase characteristics, etc. In a preferred embodiment, the fabric or region thereof is subjected in a first or earlier excitation zone to continuous or pulsed excitation under long duty cycle conditions to promote cross-linking and adhesion of the polymer in regions proximal to the surface of the fabric fibres and is thereafter subjected in a subsequent excitation zone to pulsed excitation under short duty cycle conditions to reduce cross-linking and fragmentation of the polymer in regions distal to the surface of the fabric fibres. In other preferred embodiments, there are provided both a plurality of excitation zones and a plurality of feed zones adapted to deliver one or more polymerisable monomers and/or one or more reactive or non-reactive gases to one or more regions of the fabric.

Thus in yet another aspect of the invention there is provided a method for making a fabric having a laundry-durable finish by excitation-induced graft polymerisation of a polymerisable monomer, the method comprising

a) exposing the fabric or a region thereof to polymerisable monomer, and

b) exciting the polymerisable monomer within a plurality of monomer excitation zones, and wherein the fabric or one or more regions thereof is subjected to different excitation conditions within different excitation zones.

In preferred embodiments herein, the fabric is a natural or semi-natural yarn-based woven fabric, especially silk, and the method includes the step of drying the substrate to a moisture regain (at 21° C., 65% RH) of at least about 5%, preferably at least about 6% and more preferably at least about 8% prior to exposing the fabric to the polymerisable monomer, this being valuable herein for achieving fabrics with optimum stain resistance and durability.

The protocol for the oil repellency test (AATCC 118-1997) is as follows. Drops of hydrocarbon liquids of various surface tensions are placed on the fabric's surface and the extent of wetting determined visually. The standard liquids and corresponding surface tensions in dyn/cm (mNm⁻¹) at 25° C. for each rating are:

1—refined mineral oil (31.0)

2—65/35 vol % (21° C.) mix of refined mineral oil and n-hexadecane (29.2)

3—n-hexadecane (27.3)

4—n-tetradecane (26.2)

5—n-dodecane (24.6)

6—n-decane (23.6)

7—n-octane (21.3)

8—n-heptane (19.6)

The test fabric is placed face up on white blotting paper on a flat horizontal surface. Beginning with liquid No. 1, carefully place drops approximately 5 mm in diameter or 0.05 ml in volume on the fabric or region thereof in five locations. Observe the drops for 30 sec from an approximately 45° angle. Wetting of the fabric is normally shown as darkening at the liquid/fabric interface. On black or dark fabrics, wetting can be detected by a loss of ‘sparkle’ within the drop. If at least three of the five drops do not penetrate or wet the fabric and do not show wicking around the drops, place drops of test liquid No. 2 on an adjacent site and repeat. Continue with progressively lower surface tension liquids until at least three of the five drops wet or show wicking into the fabric within 30 seconds. The liquid's AATCC oil repellency rating is the highest numbered liquid for which at least three of the five drops do not wet or wick into the fabric. An intermediate number may be given for a borderline pass. An example is where three of more of the five drops are rounded, however, there is partial darkening of the specimen around the edge of the drop.

The protocol for the water repellency test is as follows. A series of standard test solutions made of isopropyl alcohol and distilled water in various proportions and surface tensions are applied dropwise to fabric's surface and the extent of wetting determined visually. The standard liquids and corresponding surface tensions in dyn/cm at 25° C. for each rating are:

0—100% water (−)

1—10% alcohol+90% water (42)

2—20% alcohol+80% water (33)

3—30% alcohol+70% water (27.5)

4—40% alcohol+60% water (25.4)

5—50% alcohol+50% water (−)

6—60% alcohol+40% water (−)

7—70% alcohol+30% water (−)

8—80% alcohol+20% water (−)

9—90% alcohol+10% water (−)

10—100% alcohol (−)

The test fabric is placed face up on white blotting paper on a flat horizontal surface. Beginning with liquid No. 0, carefully place drops approximately 5 mm in diameter or 0.05 ml in volume on the fabric or region thereof in three locations at least 2 in (5.1 cm) apart. Observe the drops for 10 sec from an approximately 45° angle. If at least two of the three drops do not penetrate or wet the fabric and do not show wicking around the drops, place drops of test liquid No. 1 on an adjacent site and repeat. Continue with progressively lower surface tension liquids until at least two of the three drops wet or show wicking into the fabric within 10 seconds. The liquid's water repellency rating is the highest numbered liquid for which at least two of the three drops do not wet or wick into the fabric as evidenced by the drops remaining spherical or hemispherical in shape.

Typical laundry wash conditions for the multicycle wash tests performed herein uses test samples of size 20×20 cm, a 40° C. short wash (25 min wash, 75 min total wash cycle time) performed in a Miele 698 with 110 g of a regular European automatic wash powder under medium hardness (10 US gpg) and soil conditions—about 1.8 kg of soiled household articles including bedding, towels and tea-towels—followed by tumble drying at 55° C. for 45 min. The wash powder is a spray-dried detergent containing approximately (by weight of finished product) 8% anionic surfactant (LAS—linear alkyl benzene sulfonate), 17% aluminosilicate builder, 23% sodium sulfate and 7% sodium carbonate, with various dry admixes including 3% nonionic surfactant (Dobanol 45-E7), 13% percarbonate bleach, 4% tetraacetylethylenediamine bleach activator, 7% sodium carbonate, 4% silicate, 3% citric acid, the remainder enzymes, perfumes, minors and moisture. These testing conditions are sometimes referred to herein as ‘cotton cycle’ conditions. Testing is also performed herein in the Miele under so-called ‘gentle wash’ conditions, typified by a smaller number (approximately half) of the main wash and total wash revolutions of cotton cycle conditions.

The invention will now be described by way of example with reference to the accompanying drawing in which FIG. 1 is a schematic representation of a fabric finishing unit suitable for use in plasma-induced graft polymerization process embodiments of the invention.

Referring to FIG. 1, the fabric finishing unit generally comprises vacuum chamber housing 1 equipped with plasma-generating means 2, fabric-supply and transport mechanism 3, liquid feed system 4, gas feed 5, and vacuum system 6. Plasma generating means 2 generally comprises internal powered electrode 7, internal earthed electrode 8, temperature-regulating means 9, Rf generator 10 including a power supply and meter (not shown), pulse generator 11 and pulse monitoring means 12. Temperature-regulating means 9 is used to heat or cool one of the electrodes, preferably the powered electrode 7, to the required operating temperature. Fabric-supply and transport mechanism 3 comprises feed roll 13 and take-up roll 14, the fabric to be treated passing between electrodes 7 and 8 at a predetermined web speed and in contact with the temperature-regulated electrode. Liquid feed system 4 comprises one or more ultrasonic nozzles 15 with corresponding metering pumps 16 and valves 17 and vaporization tube 18 whereby the atomized monomer is delivered into housing 1 in vaporized form and deposited on the fabric by condensation. Gas feed 5 comprises mass flow controller 19 for controlling gas flow rate, gas feed being optionally used either in combination with or in place of liquid feed as described hereinabove. Vacuum system 6 comprises flow control valve 20 and absolute pressure gauge 21 communicating by way of liquid nitrogen cold trap 22 (base pressure of 3 mTorr) to vacuum pump means 23 (two stage rotary pump).

### EXAMPLE 1

The fabric finishing unit of FIG. 1 is used for used for graft polymerizing 1H, 1H,2H,2H-perfluorooctyl acrylate (Mwt 418, density 1.554 c/cm³) to knitted cotton fabric having a basis weight of 140 g/m², an air permeability (Textest FX3300;125 Pa) of 78 ml cm⁻² s⁻¹, and a fibre surface area (N₂-based BET) of 0.55 m²/g and which has been preconditioned by drying to a moisture regain (at 21° C., 65% RH) of 8%. The monomer is introduced in vapor form via gas feed 5 to a pressure of 80 mTorr at 20° C. and the equipment operated in static mode (web speed 0 m/min). The conditions employed are as follows: 13.56 MHz Rf generator, electrode dimensions 35 cm×40 cm, liquid feed system 4 closed, electrode temperature 20° C., peak power 40 W, plasma on-time 40 μs, plasma off-time 10,000 μs, average excitation power density 1.14×10⁻⁴ W/cm², web width 35 cm, plasma polymerization time 10 min, monomer flow rate 2.63×10⁻⁵ mols/min, deposition efficiency 60%, and average fibre-coating thickness (estimated) 4.0 nm. The treated fabrics demonstrate excellent oil- and water-stain repellency as made and after multi-cycle laundry cleaning under medium soil conditions and multi-cycle dry cleaning. The air permeability, fibre surface area, handle and drape remain essentially unaffected by the plasma treatment. The treated fabrics also demonstrate improved drying characteristics, reduced dye pick-up and improved whiteness/colour fidelity and malodor resistance. When the treatment is repeated twice under identical conditions (estimated fibre-coating thickness of 8.0 nm), the durability of stain repellency is further enhanced under both gentle and cotton multi-cycle conditions without negatively impacting textile attributes.

### EXAMPLE 2

The fabric finishing unit of FIG. 1 is used for used for graft polymerizing 1H, 1H,2H,2H-perfluorooctyl acrylate (Mwt 418, density 1.554 c/cm³) to woven silk fabric having a basis weight of 82 g/m², an air permeability (Textest FX3300; 125 Pa) of 72 ml cm⁻² s⁻¹, and a fibre surface area (N₂-based BET) of 0.45 m²/g and which has been preconditioned by drying to a moisture regain (at 21° C., 65% RH) of 6%. The conditions employed are as follows: 13.56 MHz Rf generator, electrode dimensions 35 cm×40 cm, vaporization tube 18 heated to 300° C., gas feed 5 closed, electrode temperature 15° C., operating pressure 100 mTorr, peak power 40 W, plasma on-time 100% μs, plasma off-time 12,500 μs, average excitation power density 2.27×10⁻⁴ W/cm², web speed 0.6 m/min, web width 35 cm, monomer feed rate 0.08 ml/min, deposition efficiency 50% and average fibre-coating thickness (estimated) of 5.2 nm. The treated fabrics demonstrate excellent oil- and water-stain repellency as made and after multi-cycle laundry cleaning under medium soil conditions and multi-cycle dry cleaning. The air permeability, fibre surface area, handle and drape remain essentially unaffected by the plasma treatment. The treated fabrics also demonstrate improved drying characteristics, reduced dye pick-up and improved whiteness/colour fidelity and malodor resistance. When the treatment is repeated twice under identical conditions (estimated fibre-coating thickness of 10.4 nm), the durability of stain repellency is further enhanced under both gentle and cotton multi-cycle conditions without negatively impacting textile attributes.

### EXAMPLE 3

The fabric finishing unit of FIG. 1 is used for used for graft polymerizing 1H, 1H,2H-perfluoro-dodecene (Mwt 546, density 1.711 g/cm³) to knitted cotton fabric having a basis weight of 140 g/m², an air permeability (Textest FX3300; 125 Pa) of 78 ml cm⁻² s⁻¹, and a fibre surface area (N₂-based BET) of 0.55 m²/g and which has been preconditioned by drying to a moisture regain (at 21° C., 65% RH) of 8%. The monomer is introduced in vapor form via gas feed 5 to a pressure of 60 mTorr at 20° C. and the equipment operated in static mode (web speed 0 m/min). The conditions employed are as follows: 13.56 MHz Rf generator, electrode dimensions 35 cm×40 cm, liquid feed system 4 closed, electrode temperature 20° C., peak power 40 W, plasma on-time 40% μs, plasma off-time 10,000 μs, average excitation power density 1.14×10⁻⁴ W/cm², web width 35 cm, plasma polymerization time 15 min, monomer flow rate 1.97×10⁻⁵ mols/min, deposition efficiency 50%, and average fibre-coating thickness (estimated) 4.37 nm. The treated fabrics demonstrate excellent oil- and water-stain repellency as made and after multi-cycle laundry cleaning under medium soil conditions and multi-cycle dry cleaning. The air permeability, fibre surface area, handle and drape remain essentially unaffected by the plasma treatment. The treated fabrics also demonstrate improved drying characteristics, reduced dye pick-up and improved whiteness/colour fidelity and malodor resistance. When the treatment is repeated twice under identical conditions (estimated fibre-coating thickness of 8.74 nm), the durability of stain repellency is further enhanced under both gentle and cotton multi-cycle conditions without negatively impacting textile attributes.

### EXAMPLE 4

The fabric finishing unit of FIG. 1 is used for used for graft polymerizing 1H, 1H,2H-perfluoro-dodecene (Mwt 546, density 1.711 g/cm³) to woven silk fabric having a basis weight of 82 g/m², an air permeability (Textest FX3300; 125 Pa) of 72 ml cm⁻² s⁻¹, and a fibre surface area (N₂-based BET) of 0.45 m²/g and which has been preconditioned by drying to a moisture regain (at 21° C., 65% RH) of 6%. The conditions employed are as follows: 13.56 MHz Rf generator, electrode dimensions 35 cm×40 cm, vaporization tube 18 heated to 300° C., gas feed 5 closed, electrode temperature 15° C., operating pressure 100 mTorr, peak power 40 W, plasma on-time 100 μs, plasma off-time 12,500 μs, average excitation power density 2.27×10⁻⁴ W/cm², web speed 0.4 m/min, web width 35 cm, monomer feed rate 0.09 ml/min, deposition efficiency 38% and average fibre-coating thickness (estimated) of 6.6 nm. The treated fabrics demonstrate excellent oil- and water-stain repellency as made and after multi-cycle laundry cleaning under medium soil conditions and multi-cycle dry cleaning. The air permeability, fibre surface area, handle and drape remain essentially unaffected by the plasma treatment. The treated fabrics also demonstrate improved drying characteristics, reduced dye pick-up and improved whiteness/colour fidelity and malodor resistance. When the treatment is repeated twice under identical conditions (estimated fibre-coating thickness of 13.2 nm), the durability of stain repellency is further enhanced under both gentle and cotton multi-cycle conditions without negatively impacting textile attributes.

What is claimed is:

1. A method for making a fabric having a laundry-durable finish by excitation-induced graft polymerisation of a polymerisable monomer, the method comprising:
a) exposing the fabric or a region thereof to polymerisable monomer, and
b) exciting the polymerisable monomer within a monomer excitation zone, and wherein the polymerisable polymer and the exposure and excitation conditions are such that the resulting polymer-coated fabric or region thereof has an average fibre-coating thickness of from about 1.5 to about 25 nm, a coating abrasion resistance of at least about 1000 rubs (Martindale Abrasion Test, ISO 12947-2, 12 kPa load, 50% minimum finishing performance) and wherein the polymer is graft-polymerised substantially wholly on or in the individual fabric fibres with substantially no coalescence of fibre bundles whereby the air permeability of the fabric or region thereof after treatment is within about ±20% of that of the untreated fabric.

2. The method of claim 1 wherein the fabric or region thereof has an average fibre-coating thickness of from about 2.5 to about 20 nm, a coating abrasion resistance of at least about 3000 rubs and wherein the air permeability of the fabric or region thereof after treatment is within about ±15% of that of the untreated fabric.

3. The method of claim 2 wherein the fabric or region thereof has an average fibre-coating thickness of from about 3 to about 15 nm, a coating abrasion resistance of at least about 3000 rubs and wherein the air permeability of the fabric or region thereof after treatment is within about ±10% of that of the untreated fabric.

4. The method of claim 1 wherein the polymerisable monomer is selected to impart one or more laundry-durable finishes selected from oleophobicity, hydrophobicity, stain repellency stain release, soil-resistance, soil release, malodor resistance, malodor release, crease resistance, softness, flame retardancy, color-bleeding resistance, dye-transfer inhibition and odor receptivity.

5. The method of claim 4 wherein the polymer-coated fabric or region thereof has an average hexadecane wetting hysteresis factor of less than about ±30%, wherein the hexadecane wetting hysteresis factor is defined as (θₐ^{hex}−θᵣ^{hex})/θₐ^{hex}, and θₐ^{hex}, θᵣ^{hex} are respectively the advancing and receding contact angles for n-hexadecane on the polymer coated fabric or region thereof at 20° C.

6. The method of claim 5 wherein the fabric or region thereof has an average water wetting hysteresis factor of less than about ±30% wherein the water wetting hysteresis factor is defined as (θₐ^{wat}−θᵣ^{wat})/θₐ^{wat}, and θₐ^{wat}, θᵣ^{wat} are respectively the advancing and receding contact angles for deionised water on the polymer coated fabric or region thereof at 20° C.

7. The method according to claim 1 wherein the excitation zone is selected from radiofrequency- and microwave-generated plasma zones.

8. The method of claim 1 wherein the fabric is a natural or semi-natural woven fabric selected from cotton, silk, wool, linen, rayon and mixtures thereof as well as blends thereof with one or more synthetic polymers.

9. The method of claim 8 wherein the fabric is silk or a silk blend and wherein the polymerisable monomer is selected to impart a laundry-durable oleophobic finish to the fabric or region thereof.

10. The method of claim 1 wherein the excitation zone is a pulsed plasma having an on-time for unsaturated vapor-phase polymerisable monomers of from about 5 μs to about 100 μs, an on-time for saturated polymerisable monomers of from about 40 μs to about 2 ms, an off-time of at least 1 ms, a duty cycle in the range from about 1/2 to about 1/10000, and an average excitation power density in the range from about 10⁻⁷ to about 10⁻¹ Watts/cm².

11. The method of claim 10 wherein the excitation zone is a sub-atmospheric vacuum pulsed plasma having an on-time for unsaturated vapor-phase polymerisable monomers of from about 20 μs to about 70 μs, an on-time for saturated polymerisable monomers of from about 100 μs to about 1 ms, an off-time of from about 2 ms to about 50 ms, a duty cycle in the range from about 1/100 to about 1/5000 for unsaturated vapor-phase monomers and from about 1/4 to about 1/300 for saturated vapor-phase monomers, and an average excitation power density in the range from about 10⁻⁶ to about 10⁻² Watts/cm².

12. The method of claim 1 wherein the polymerisable monomer is a saturated or unsaturated long-chain fluoro-substituted monomer containing an uninterrupted fluoroalkyl group of formula CₙX₂ₙ₊₁ wherein each X is independently selected from the group consisting of halogen, H, and O-linked sidechain substituents, and wherein the fluoroalkyl group contains at least n fluoro substituents wherein n is in the range from about 5 to about 15, and wherein the fluoroalkyl group contains a linear fluorocarbon segment of at least 5 carbon atoms in length.

13. The method of claim 12 wherein the fluoroalkyl group contains at least 2n−3 fluoro substituents, wherein n is in the range from about 6 to about 10.

14. The method of claim 12 wherein the polymerisable monomer has the general formula [CₙX₂ₙ₊₁YTQ]ₘR, wherein R is selected from the group consisting of C₁-C₈-alkyl and alkylene, C₃-C₈-cycloalkyl and cycloalkylene, C₂-C₈-heterocycloalkyl and heterocycloalkylene, C₂-C₈-alkenyl and alkenylene, C₂-C₈-alkynyl and alkynylene, and C₄-C₈-alkadienyl and alkadienylene, each said R group being optionally substituted with one or more halogen atoms; m is from 1 to 3; T represents the moiety (C(R¹)₂)ₚ wherein each R¹ is independently selected from the group consisting of H, halogen, hydroxy, C₁-C₄ alkyl, hydroxy-substituted C₁-C₄ alkyl, halo-substituted C₁-C₄ alkyl, and mono- and poly-C₁-C₄-alkylene oxide moieties and wherein p is from 0 to 10; each Q independently represents a direct bond or a linking moiety selected from the group consisting of O, (C═O), O(C═O), (C═O)O, NR², NR²(C═O), (C═O)NR², O(C═O)NR² and (R²)₂Si, wherein, each R² independently selected from C₁-C₄ alkyl and halo-substituted C₁-C₄ alkyl groups; and Y is a direct bond or a sulphonamide group provided that when Y is a sulphonamide group, the corresponding T moiety has a p value of at least 1.

15. The method of claim 14 wherein the terminal carbon of the fluoroalkyl group or of T, if present, is free of H substituents when the corresponding group is directly connected to a Q linking moiety; and wherein the polymerisable monomer is perfluorinated when the monomer is free of Q linking moieties.

16. The method of claim 15 wherein the terminal carbon of the fluoroalkyl group or of T, if present, is substituted with two atoms or groups selected from the group consisting of halogens, C₁-C₄ alkyl and halo-substituted C₁-C₄ alkyl moieties, C₁-C₄-alkylene oxide and poly-C₁-C₄-alkylene oxide moieties having from 2 to 20 alkylene oxide moieties in the polymer chain, and combinations thereof.

17. The method of claim 14 wherein the polymerisable monomer has a rate constant for alkaline hydrolysis at pH 8 and above of less than about 1×10⁻⁵ L/mol-sec.

18. The method of claim 14 wherein the fabric as made has a surface F:C ratio as determined by XPS of at least about 1.25.

19. The method of claim 1 wherein the polymerisable monomer is of low or intermediate volatility with a boiling point in the range from about −50° C. to about 150° C. at 8000 mTorr (10.7 mbar).

20. The method of claim 1 including a plurality of excitation zones and wherein the fabric or one or more regions thereof is subjected to different excitation conditions within different excitation zones, the different excitation conditions being selected from the group consisting of different duty cycles, electrode temperatures, power parameters, pressure conditions, and electromagnetic phase characteristics.

21. The method of claim 20 wherein the fabric or region thereof is subjected in a first or earlier excitation zone to continuous or pulsed excitation under long duty cycle conditions to promote cross-linking and adhesion of the polymer in regions proximal to the surface of the fabric fibres and is thereafter subjected in a subsequent excitation zone to pulsed excitation under short duty cycle conditions to reduce cross-linking and fragmentation of the polymer in regions distal to the surface of the fabric fibres.

22. The method of claim 20 including both a plurality of excitation zones and a plurality of feed zones adapted to deliver one or more polymerisable monomers and/or one or more reactive or non-reactive gases to one or more regions of the fabric

23. The method of claim 1 wherein the fabric is a natural or semi-natural yarn-based woven fabric and wherein the method includes the step of drying the substrate to a moisture regain of (at 21° C., 65% RH) of at least about 5% prior to exposing the fabric to the polymerisable monomer.

24. A fabric having a laundry-durable finish made by graft polymerisation of a polymerisable monomer, the polymer-coated fabric or region thereof having an average fibre-coating thickness of from about 1.5 to about 25 nm and a coating abrasion resistance of at least about 1000 rubs (Martindale Abrasion Test, ISO 12947-2, 12 kPa load, 50% minimum finishing performance), the polymer being graft-polymerised substantially wholly on or in the individual fabric fibres with substantially no coalescence of fibre bundles whereby the air permeability of the fabric or region thereof after treatment is within about ±20% of that of the untreated fabric.

25. A fabric according to claim 24 made by the steps of exposing the fabric or a region thereof to polymerisable monomer, and exciting the polymerisable monomer within a monomer excitation zone.
